(19) United States
(12) Patent Application Publication
(10) Pub. No.: US 2007/0163141 A1
(43) Pub. Date: Jul. 19, 2007

(54) Method for manufacturing casings of composite hand dryers and the structure thereof

(75) Inventor: Chi-Chin Hsu, Taipei County (TW)

Correspondence Address: BIRCH STEWART KOLASCH & BIRCH, PO BOX 747, FALLS CHURCH, VA, 22040-0747, US

(73) Assignee: Hokwang Industries Co., Ltd.

(21) Appl. No.: 11/331,021

(22) Filed: Jan. 13, 2006

(51) Int. Cl. F26B 19/00; F26B 5/06

(52) U.S. Cl. 34/282; 34/60

(57) ABSTRACT

A method for manufacturing casings of composite hand dryers and the structure thereof includes the processes of severing a reproduced steel rough material to form a front casing, bending the front casing, fabricating a first side casing and a second side casing that have respectively a coupling portion, assembling one end of the front casing with the first side casing and assembling another end of the front casing with the second side casing to form a finished composite hand dryer casing. The method and structure can eliminate rusting and product strength problems. Fabrication process is simplified and production cost is lower.

### FIELD OF THE INVENTION

The present invention relates to a method for manufacturing casings of composite hand dryers and the structure thereof particularly to a method to rapidly fabricate the casings of hand dryers from reproduced steel sheets and the structure thereof.

### BACKGROUND OF THE INVENTION

Refer to FIG. 1 for the process flow of a conventional manufacturing method to fabricate the casing of a hand dryer by iron casting. At the initial casting stage, a mold has to be designed according to the profile of the hand dryer (namely the molding process); next, a molten original material (cast iron) is poured into the mold (namely the casting process); after cooling and solidified, open the mold to remove the rough blank of the hand dryer (namely the out of patterns process). As the mold has a pouring gate for casting, after the out of patterns process a strut is formed on the pouring gate that has to be removed (namely the remove surplus process); then required holes are formed on the rough blank by drilling (namely the drilling process); as the surface of the rough blank is coarse, a treatment process is performed on the surface (namely the surface polishing and plating process); finally a protective layer is formed on the surface before shipment (namely the surface coating process) to avoid scraping or leaving fingerprint marks on the surface due to hand contact.

Refer to FIG. 2 for a conventional manufacturing method to fabricate the casing of a hand dryer by die-casting of aluminum/zinc aluminum alloy. It is substantially same as the iron casting method previously discussed. It differs mainly in changing the molten original material of cast iron into the mold in the casting process to form a solid shape to placing an aluminum/zinc aluminum alloy of a less hardness on a mold, and performing a die-casting process by applying a pressure on the mold to form a desired shape.

The two methods mentioned above to fabricate the casings of hand dryers still have problems in terms of the original material and manufacturing processes, notably:
1. The hand dryer casing made from iron is preferably to have the surface coated with a layer of enamel or baking paint in the later stage fabrication process. The surface that is merely treated by polishing easily rusts as the hand dryer is mostly installed in the bathroom or toilet that is usually damp. However, coating a layer of enamel or paint requires the surface to be polished first. The cost is higher.
2. The hand dryer casing made of aluminum/zinc aluminum alloy by die-casting overcomes the rusting problem and can be finished by surface polishing. But the aluminum/zinc aluminum alloy cannot withstand a great impact. It easily forms a permanent indented trace when hit incidentally by an external force, and its aesthetic appealing is affected. Hence it still has to be treated by plating or painting after the surface polishing process to make the surface more appealing and harder.

To remedy the aforesaid problems, one commendable approach to provide sufficient strength without rusting is using reproduced steel as the rough material to fabricate hand dryer casings. At present the steel fabrication plants in Taiwan can produce the best quality of reproduced steel rough material in the world. The steel fabrication plants in Taiwan can cut the steel material in varying dimensions according to the requirements of the downstream plants, and polish the surface of the reproduced steel rough material (such as polish to become a mirror surface or smoke surface which is also called sand No. 4). The reproduced steel rough material discussed in this invention includes stainless steel sheet rough material and steel sheet rough material which has gone through surface treatment (such as anodizing, hardening process and baking paint process or the like). Refer to FIG. 3 for the process flow of treating reproduced steel sheets (stainless steel sheets) rough material by a typical Taiwan steel fabrication plant. The steel fabrication plant procures original rough material (stainless steel) from upstream vendors, and processes the material to a required thickness (namely the shaping process) according to the orders of the downstream vendors; next, polish the surface to become a mirror surface or smoke surface (namely the surface polishing process) according to actual requirements; next, coat a protective layer after polishing (namely the surface coating process); then slit the material to selected widths (namely the process of divide into strips) according to requirements; then roll the strips to a cylindrical roll through a calender (the roll up process) to become the reproduced steel (stainless steel) rough material of a selected thickness and width ordered by the downstream vendors. The following is two conventional process flows for fabricating the casings of hand dryers from the reproduced steel rough material:

Refer to FIG. 4 for a conventional manufacturing method to fabricate the casings of hand dryers by stamping reproduced steel sheet rough material. Before stamping, first, remove the protective layer of the reproduced steel sheet rough material shipped from the steel fabrication plant (namely the remove surface coating process) and slit the reproduced steel sheet rough material to required sizes (namely the severing process), and also design and prepare required molds according to the profile and holes of the hand dryer (namely the molding process); place the reproduced steel sheet rough material that has the protective layer removed in the mold for stamping (namely the stamping process), and punch holes through the holing mold (namely the holing process); remove extra fringes formed on the reproduced steel sheet rough material during the stamping and holing processes (namely the cutting process); due to the mirror surface or smoke surface is damaged during the stamping and holing processes, the surface needs an additional treating process (namely the surface polishing and plating process); finally a protective layer is coated (namely the surface coating process) before the finished product is shipped to avoid scraping or leaving fingerprint marks due to hand contact.

Refer to FIG. 5 for a conventional manufacturing method to fabricate the casings of hand dryers by stamping and welding stainless steel sheet rough material. First, slit the reproduced steel sheet rough material produced by the upstream steel fabrication plant to required sizes (namely the severing process) according to partial casings of the hand dryer; next, design and prepare molds according to the profiles of the partial casings and required holes (namely the molding process); place the severed reproduced steel sheet rough material in the molds for stamping and holing to form the partial casings with the required profiles and holes (namely the stamping and holing processes); remove the extra fringes from the reproduced steel sheet rough material that are formed during the partial casings are fabricated (namely the cutting process); in the event that the bending angle formed during the holing process does not meet requirements, another fabrication process is needed (namely the bending process); after the partial casings of the hand dryer are formed, remove the protective layer (namely the remove surface coating process); then connect the partial casings of the hand dryer by heat fusion (namely the welding process); due to the mirror surface or smoke surface is damaged during the stamping and holing processes, the surface needs an additional treating process (namely the surface polishing and plating process); finally a protective layer is coated (namely the surface coating process) before the finished product is shipped to avoid scraping or leaving fingerprint marks due to hand contact.

The previous two process flows for fabricating the hand dryer casings from the reproduced steel rough material indicate that the problems of rusting and product strength are overcome, but the complicated fabrication processes remain resolved such as surface polishing and plating, surface coating and the like. On the contrary, more processes are added such as stamping, cutting fringes, remove surface coating, welding and the like. This also increases manpower cost during product fabrication. Cutting the fringes also causes waste of material and results in a higher cost. The complicated fabrication processes create efficiency problem and a higher defective rate. All of those problems are pending to be resolved in the industry.

### SUMMARY OF THE INVENTION

Therefore the primary object of the present invention is to solve the aforesaid disadvantages. The present invention provides a simplified manufacturing method that not only can resolve the rusting and product strength problems, also can reduce production cost. In the entire fabrication process the surface of the reproduced steel sheet rough material is maintained intact, hence there is no need to do additional surface polishing and plating, and surface coating processes.

The manufacturing method according to the invention includes:

providing a reproduced steel sheet rough material;

severing the reproduced steel sheet rough material to form a front casing, a first side casing and a second side casing;

bending the front casing, first and second side casings; and

assembling one end of the front casing and the first side casing, and assembling another end of the front casing and the second side casing.

Another object of the invention is to provide a structure to simplify the fabrication process and reduce production cost. The structure includes:

a front casing which has at least one bend portion; and

a first side casing and a second side casing that have respectively a coupling portion on a corresponding surface.

The front casing has one end to couple with the coupling portion of the first side casing and another end to couple with the coupling portion of the second side casing to form a complete hand dryer casing.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a conventional manufacturing process flow chart for fabricating a hand dryer casing from cast iron.

FIG. 2 is a conventional manufacturing process flow chart for fabricating a hand dryer casing by die casting of an aluminum/zinc aluminum alloy.

FIG. 3 is a conventional manufacturing process flow chart for processing reproduced steel sheet rough material.

FIG. 4 is a conventional manufacturing process flow chart for fabricating a hand dryer casing by stamping reproduced steel sheet rough material.

FIG. 5 is a conventional manufacturing process flow chart for fabricating a hand dryer casing by stamping and welding stainless steel sheet rough material.

FIG. 6 is a manufacturing process flow chart of the invention for fabricating a composite hand dryer casing.

FIGS. 7A and 7B are perspective views of a first embodiment of the invention according to FIG. 6.

FIG. 8 is a perspective view of a second embodiment of the invention according to FIG. 6.

FIG. 9 is a manufacturing process flow chart of the invention according to FIG. 6 for severing and holing at the same time.

FIGS. 10A and 10B are perspective views of a first embodiment of the invention according to FIG. 9.

FIG. 11 is a perspective view of a second embodiment of the invention according to FIG. 9.

FIG. 12 is process flow chart of the invention for manufacturing a hand dryer casing by extending.

FIG. 13 is a perspective view of a first embodiment of the invention according to FIG. 12.

FIG. 14 is a perspective view of a second embodiment of the invention according to FIG. 12.

FIG. 15 is a perspective view of a third embodiment of the invention according to FIG. 12.

FIG. 16 is a perspective view of a fourth embodiment of the invention according to FIG. 12.

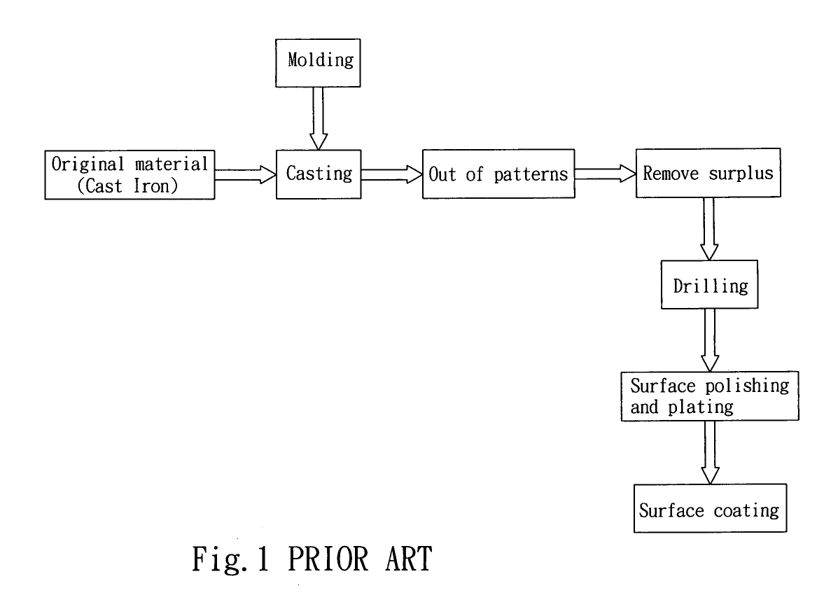

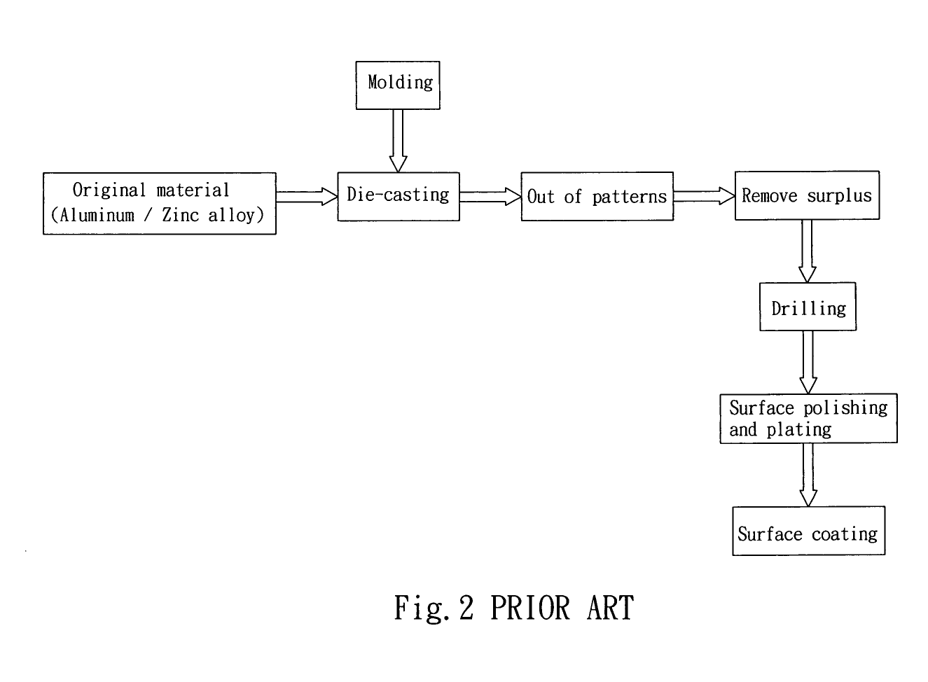

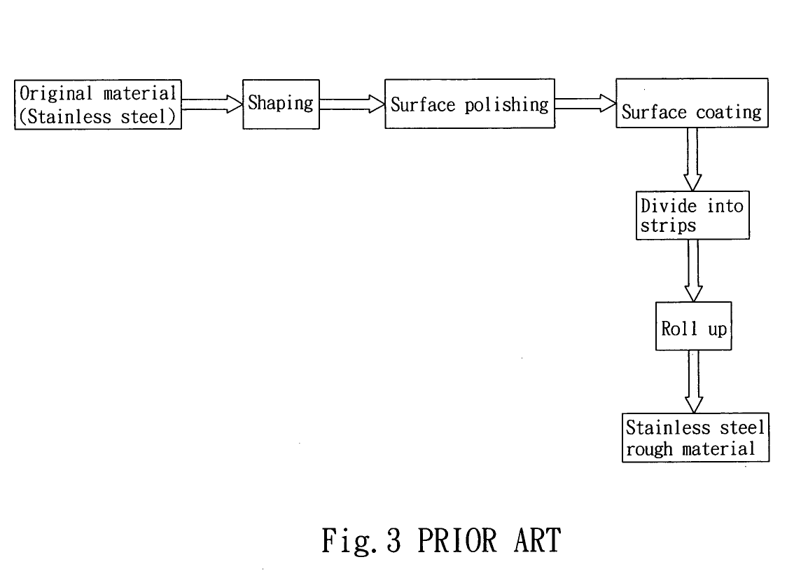

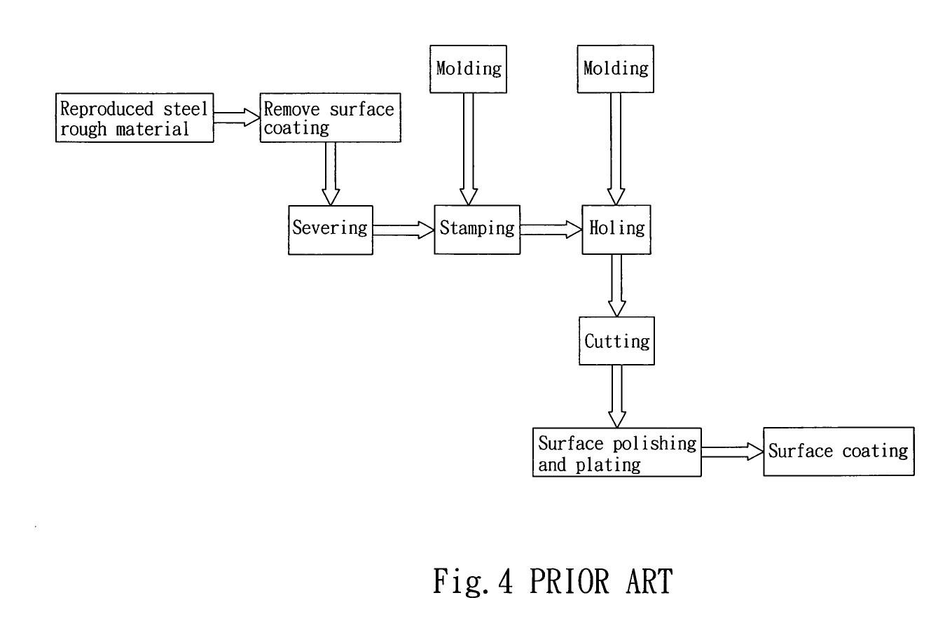

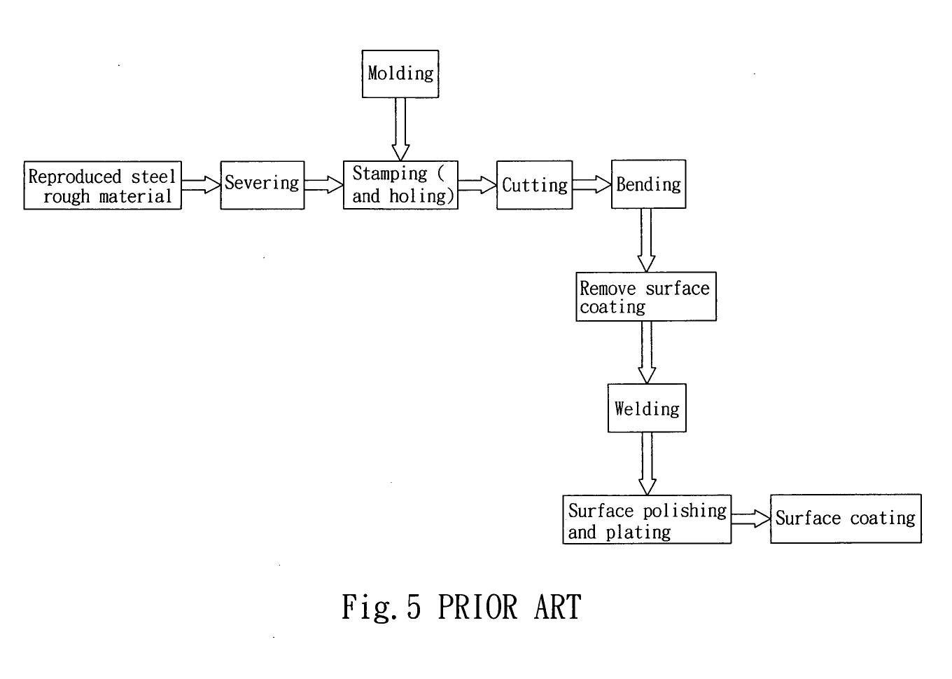

### DETAILED DESCRIPTION OF THE PREFERRED EMBODIMENTS

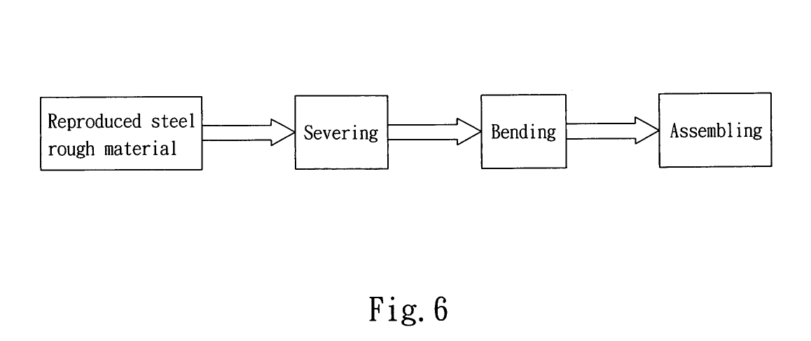

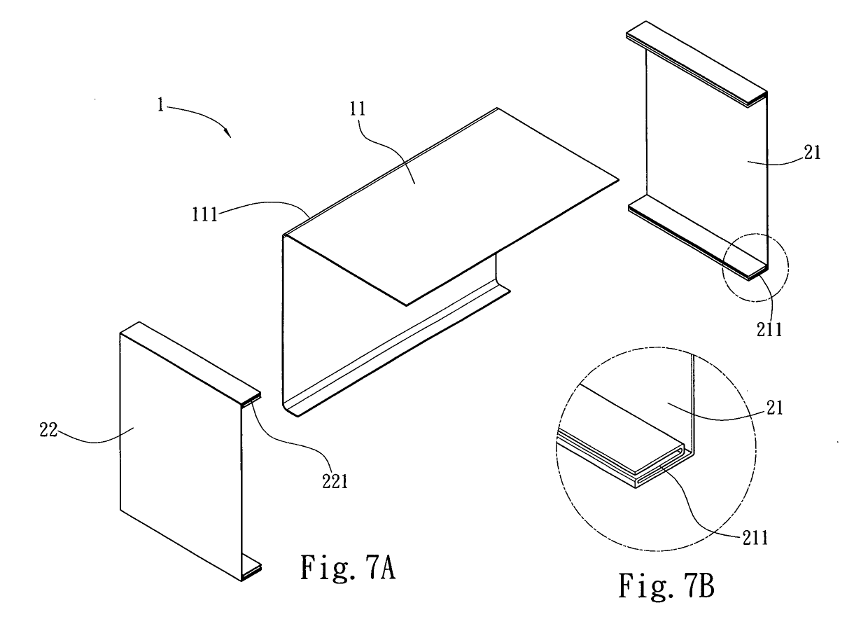

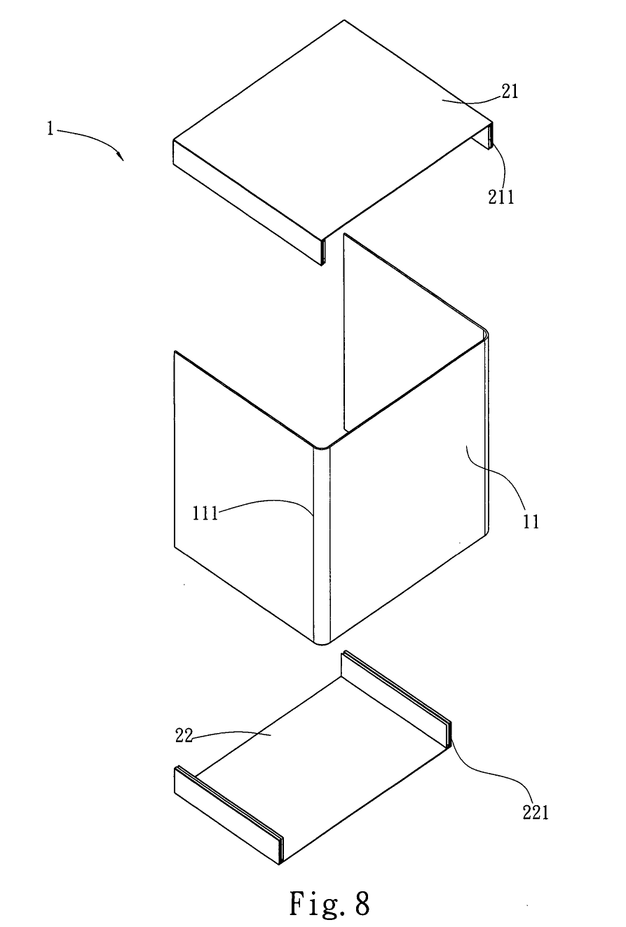

Please refer to FIGS. 6, 7A, 7B and 8 for the manufacturing process flow of the invention for fabricating a composite hand dryer casing 1 and a first and second embodiment. The composite hand dryer casing 1 is made from reproduced steel rough material. First, sever the reproduced steel rough material to form a front casing 11, a first side casing 21 and a second side casing 22; next, bend the front casing 11, first side casing 21 and second side casing 22; finally assemble one end of the bent front casing 11 with the first side casing 21 and another end with the second side casing 22. The finished product does not have the problems of rusting and inadequate product strength. The fabrication process is also simplified and can reduce production cost. The structure of the composite hand dryer casing 1 fabricated by the method set forth above includes a front casing 11, a first side casing 21 and a second side casing 22. The front casing 11 has two bend portions 111. The first and second side casings 21 and 22 have respectively two coupling portions 211 and 221 on the corresponding surfaces. Similarly, the front casing 11 also has two coupling portions on two ends (not shown in the drawings). By coupling one end of the front casing 11 with the coupling portion 211 of the first side casing 21 and another end with another coupling portion 221 of the second side casing 22, the composite hand dryer casing 1 can be produced without the rusting and product strength problems. The fabrication process also is simplified and production cost can be reduced.

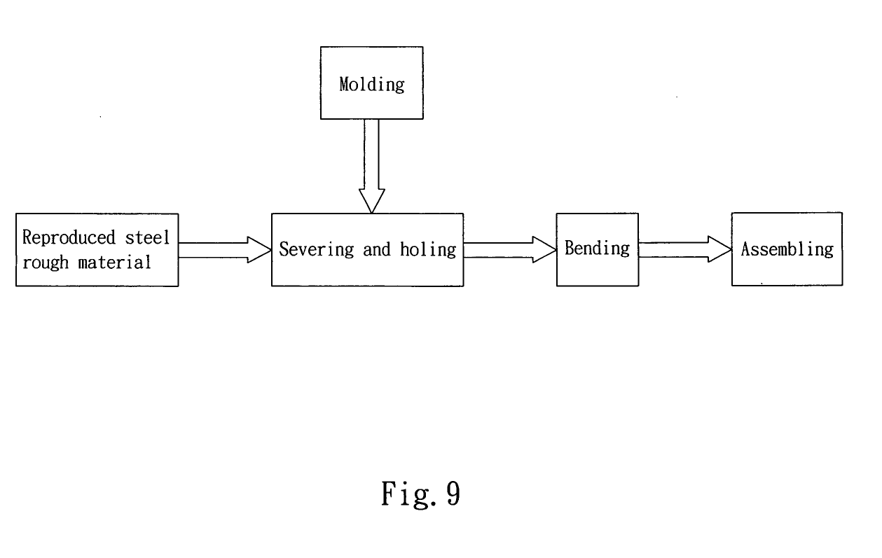

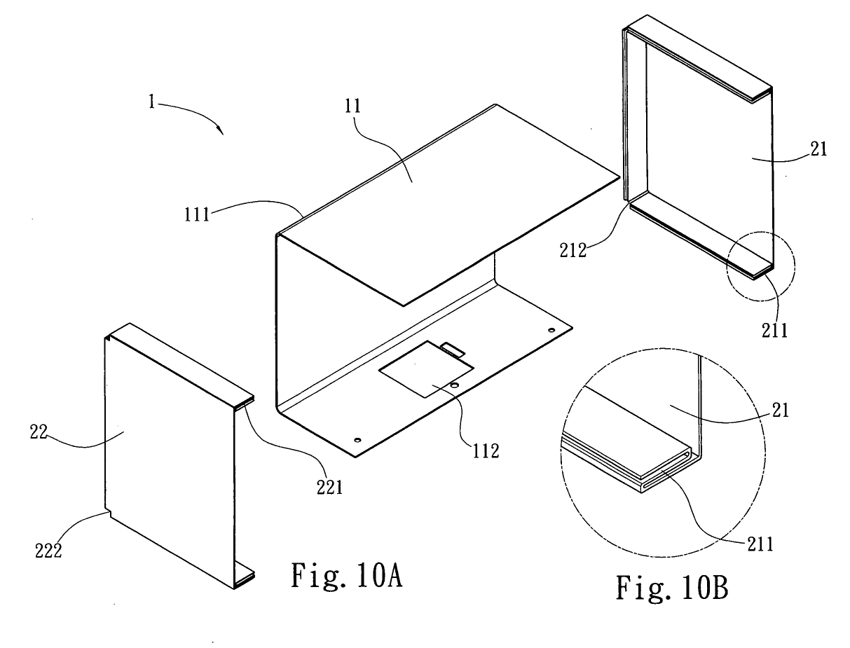

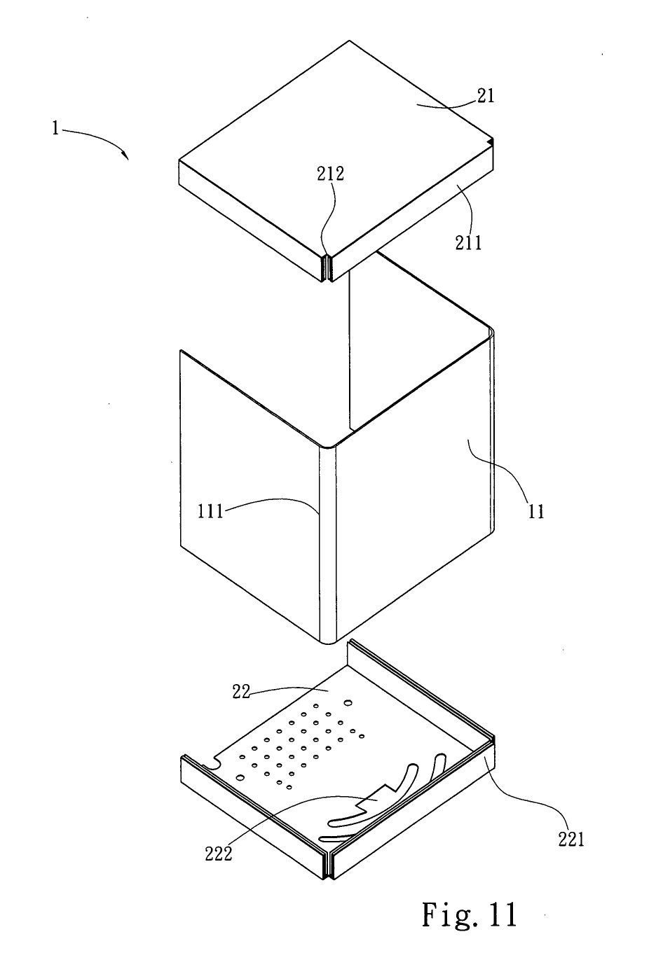

Refer to FIGS. 6, 9, 10A, 10B and 11 for the severing and holding processes according to the manufacturing method depicted in FIG. 6, and the first and second embodiments. FIG. 9 is largely like FIG. 6. It differs by including a holing process in the severing process. Hence a mold that can perform severing and holing processes has to be designed and prepared in advance to sever and punch holes on the front casing 11, first side casing 21 and second side casing 22. This process also can fabricate the composite hand dryer casing 1 without the rusting and product strength problems. The fabrication process also is simplified and production cost can be reduced. The structure of the composite hand dryer casing 1 fabricated by the method previously discussed includes a front casing 11, a first side casing 21 and a second side casing 22. The front casing 11 has two bend portions 111 and a plurality of holes 112. The first and second side casings 21 and 22 have respectively three coupling portions 211 and 221 on the corresponding surfaces and a plurality of holes 212 and 222. Similarly, the front casing 11 also has two coupling portions on two ends (not shown in the drawings). By coupling one end of the front casing 11 with the coupling portion 211 of the first side casing 21 and another end with another coupling portion 221 of the second side casing 22, the composite hand dryer casing 1 can be produced without the rusting and product strength problems. The fabrication process also is simplified and production cost can be reduced.

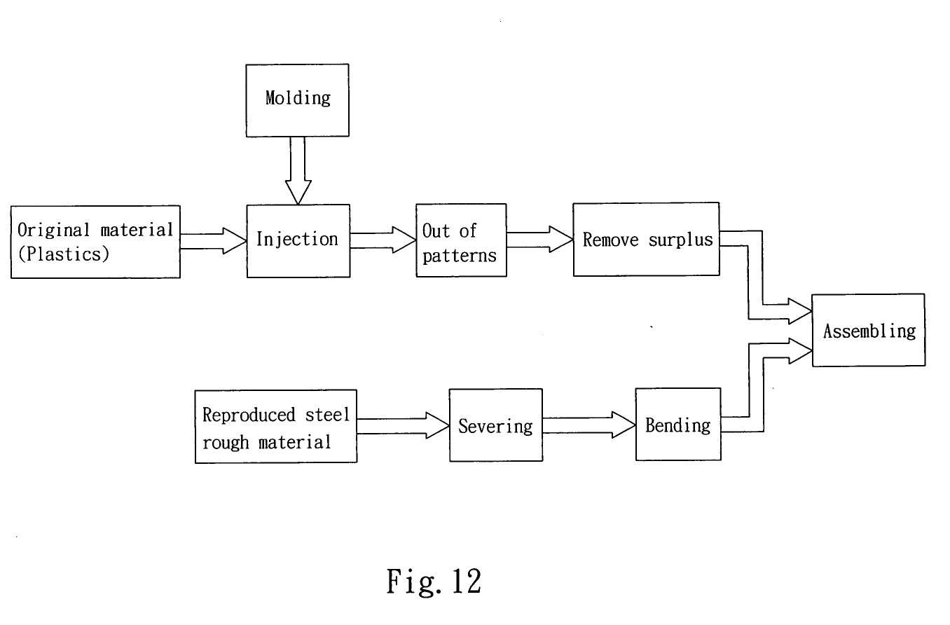

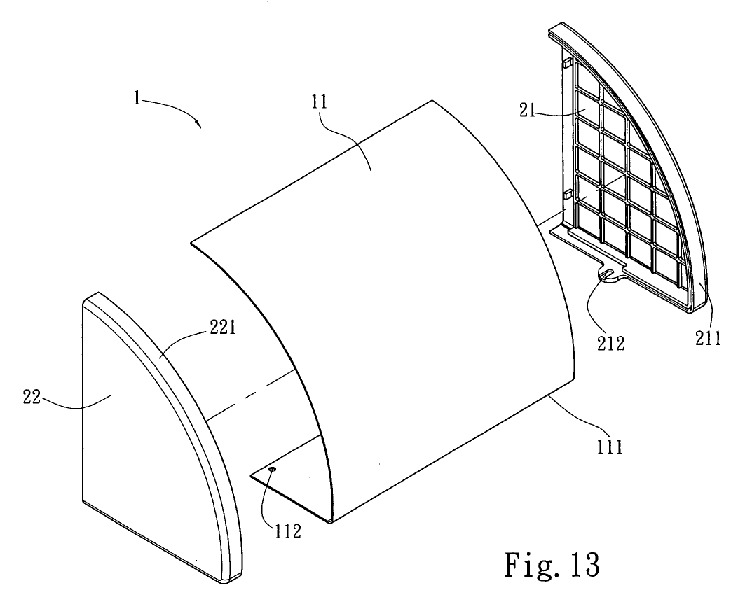

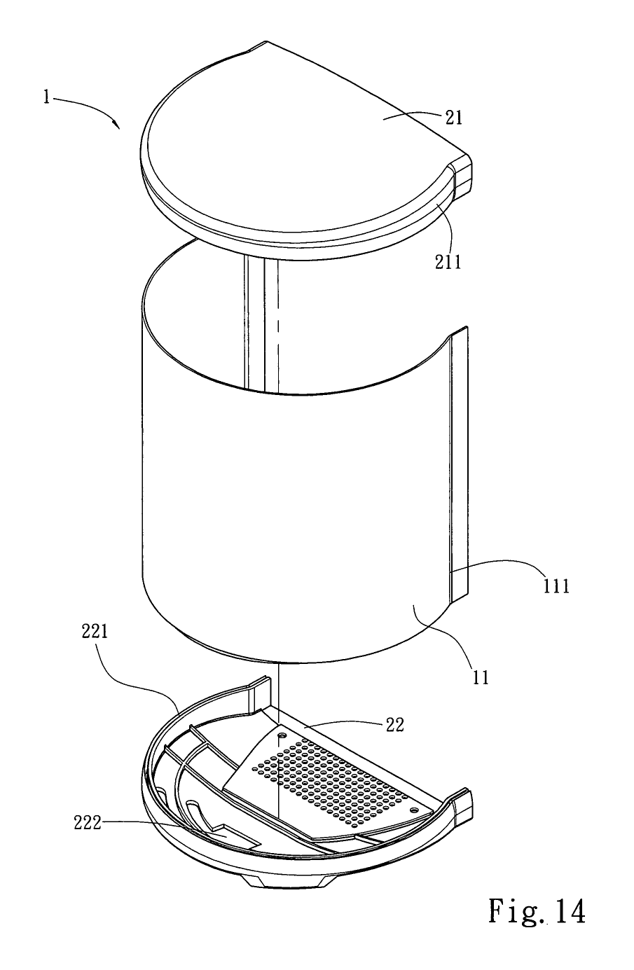

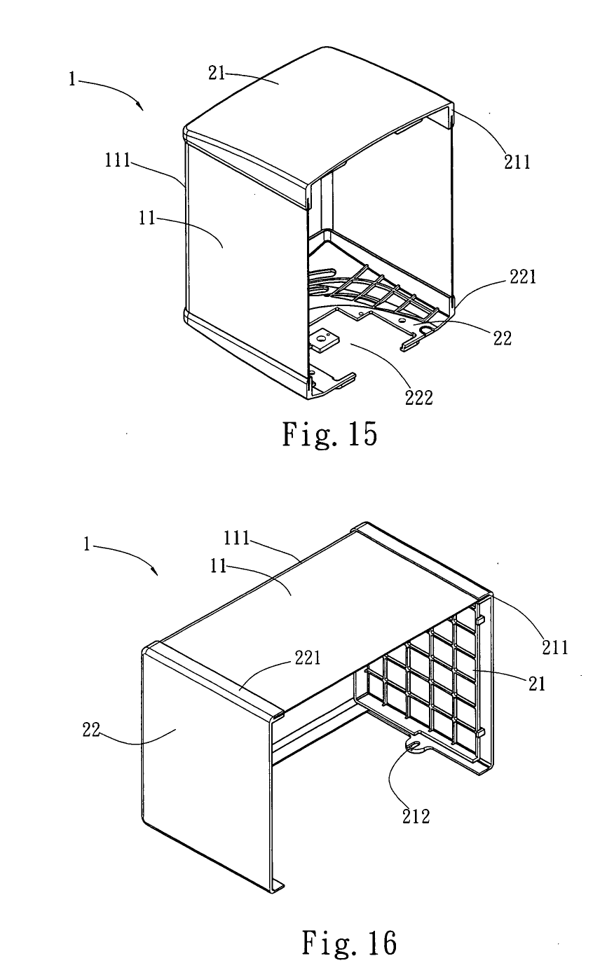

Refer to FIGS. 12 through 16 for the process of manufacturing a hand dryer casing by extending, and a first, second, third and fourth embodiments according to FIG. 12. In the process the composite hand dryer 1 is made from reproduced steel rough material which is severed to form a front casing 11. The front casing 11 then is bent in a bending process. In addition, a mold is designed and prepared to form a first side casing 21 and a second side casing 22 through injection of plastics as the original material. After the processes of out of patterns and remove surplus, the first and second side casings 21 and 22 are formed. Then the bent front casing 11 is coupled with the first side casing 21 on one end and the second side casing 22 on another end in an assembling process to become a finished product. The product also can be fabricated without the rusting and product strength problems. The fabrication process also is simplified and production cost can be reduced. The structure of the composite hand dryer casing 1 formed by extending previously discussed includes a front casing 11, a first side casing 21 and a second side casing 22. The front casing 11 has at least one bend portion 111. The first and second side casings 21 and 22 have respectively at least one coupling portion 211 and 221 on the corresponding surfaces, and at least one hole 212 and 222. Similarly, the front casing 11 also has two coupling portions on two ends (not shown in the drawings). By coupling one end of the front casing 11 with one coupling portion 211 of the first side casing 21 and another end with another coupling portion 221 of the second side casing 22, the composite hand dryer casing 1 can be produced without the rusting and product strength problems. The fabrication process also is simplified and production cost can be reduced.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A method for manufacturing a composite hand dryer casing, comprising the steps of:
providing a reproduced steel rough material;
severing the reproduced steel rough material to form a front casing, a first side casing and a second side casing;
bending the front casing, the first side casing and the second side casing; and
assembling one end of the bent front casing with the first side casing and assembling another end of the front casing with the second side casing.

2. The method of claim 1, wherein the step of severing the reproduced steel rough material to form a front casing, a first side casing and a second side casing further includes providing a mold to form holes on the front casing, the first side casing and the second side casing during the severing process.

3. A method for manufacturing a composite hand dryer casing, comprising the steps of:
providing a reproduced steel rough material;
severing the reproduced steel rough material to form a front casing;
bending the front casing;
providing an original material of plastics;
providing a mold to do injection of the original material to form a first side casing and a second side casing; and
assembling one end of the bent front casing with the first side casing and assembling another end of the front casing with the second side casing.

4. A composite hand dryer structure, comprising:
a front casing which has at least one bend portion; and
a first side casing and a second side casing that have respectively a coupling portion on corresponding surfaces thereof;
wherein the front casing has one end coupling with the coupling portion of the first side casing and another end coupling with the coupling portion of the second side casing to form a composite hand dryer casing.

5. The composite hand dryer structure of claim 4, wherein the front casing has a coupling portion on each of the two ends.

6. The composite hand dryer structure of claim 4, wherein the front casing has holes formed thereon.

7. The composite hand dryer structure of claim 4, wherein the first side casing and the second side casing have holes formed thereon.
